(19) United States
(12) Patent Application Publication
(10) Pub. No.: US 2008/0277078 A1
(43) Pub. Date: Nov. 13, 2008

(54) "Original" Canvas Bridge

(75) Inventor: Stephen Shelby Sawyer, Versailles, KY (US)

Correspondence Address: Stephen Sawyer, 143 Lexington Street, 1137 Buck Run Road, Versailles, KY, 40383, US

(73) Assignee: Stephen Shelby Sawyer, Versailles, KY (US)

(21) Appl. No.: 11/746,545

(22) Filed: May 9, 2007

(51) Int. Cl. B44D 3/18

(52) U.S. Cl. 160/374.1

(57) ABSTRACT

The Canvas Bridge is made of any material which is sturdy, durable and still retains some flexibility. It can be made of materials with a wide variety of properties. The design fits all artist easels. It is a long rectangular piece of material with a variety of lengths. Each end is elongated on the bottom side, creating the visual image of a bridge. Each end has a sharpened metal screw, nail, or nail-like material extending approximately ¼ inch from the bottom of each elongated end and it is these sharp points which are pushed into the canvas stretcher bars (stretcher bars are the wooden frame upon which the canvas is stretched).

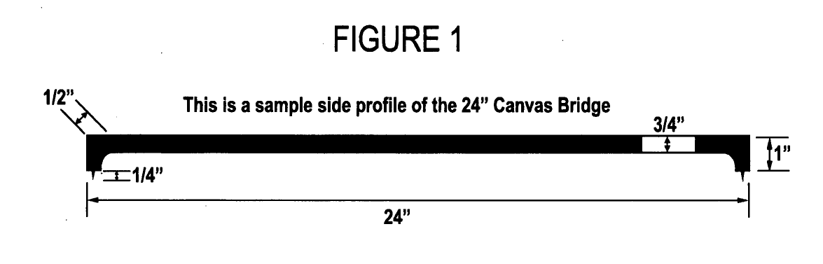

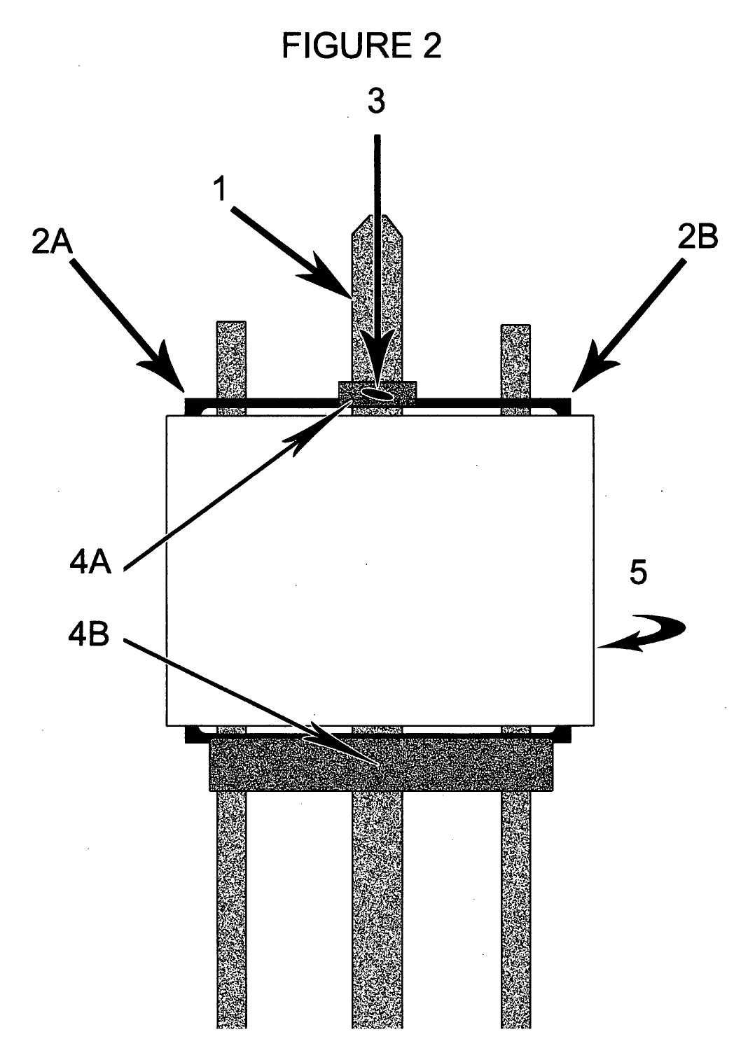

The Canvas Bridge is made of any material which is sturdy, durable, and has some flexibility. It can be made of materials with strengths and flex properties like those found in various woods, plastics, man-made materials, metals, or chemically enhanced organic materials. They can be made exclusively with or in combination/conjunction with any or all previously mentioned materials. The design is a long rectangular piece of material. The width can be as narrow is ½ inch and as wide as 2 inches. It can be approximately ½-1 inch tall with a variety of lengths such as 10, 16, 24, 32, 48 inches etc, with the height and/or width thickness increasing with larger lengths. Each end is elongated on the bottom side, creating the visual image of a bridge, from which a sharpened metal nail, or nail like material, extending approximately ¼ inch is pushed into the canvas stretcher bars (stretcher bars are the wooden frame upon which the canvas is stretched). It is possible to use only one Canvas Bridge for securing the canvas by affixing it to the upper stretcher bar. When a second Canvas Bridge is employed on the bottom stretcher bar it allows for full painting coverage on the bottom areas of the canvas, the same capability the artist enjoys on the uppermost portion of the canvas when the top Canvas Bridge is used.

### BRIEF DESCRIPTION OF THE DRAWINGS

Figure One:

This side profile of the Canvas Bridge shows two sharp nails or screws extending approximately ¼″ beyond the bridge-like ends which, when secured, penetrate into the wooden stretcher bars. These same bridge-like ends of the Canvas Bridge, while extending downward and becoming securely flush with the stretcher bars also allow the necessary gap of approximately ¼″ for adequate downward pressure to be applied, top down, from the center, to hold the canvas firmly within the easel. It is the application of the centered and downward force that redistributes the easel's holding pressure out to the ends, thus preventing the bending of the stretcher bars at their center, where they are the weakest, which causes the canvas material to sag. The ¼″ gap also creates a space which allows the entire upper and lower portion of the canvas to be painted because most artist easels have a lip on the upper and lower adjustable slides which hold the canvas on the easel. Two Canvas Bridges can be used on both the upper and lower stretcher bars of the canvas simultaneously.

Figure Two:

Figure two visually demonstrates and locates the positions and usage of the Canvas Bridge.

#1 indicates the easel where the canvas is securely held with a Canvas Bridge on the top and bottom of the canvas.

#2a and #2b are the identical ends of the Canvas Bridge showing how they appear when they are firmly affixed into the stretcher bars, which is the wooden frame that holds the canvas cloth material upon which the paint is applied.

#3 is the thumb screw which is manually tightened after manually pulling down the easel's upper slide upon the top stretcher bar to hold the canvas tightly in place.

#4a is the upper slide of the easel which uses #3, the thumb screw, to hold the canvas tight. With the Canvas Bridge, this upper slide pushes down onto the bridge, rather than the top of the canvas stretcher bar, and applies the downward pressure to the ends of the canvas bridge thus removing the pressure from the stretcher bar which bends under pressure and causes the canvas to sag. This upper slide has a front lip, which can be seen in Figure two. This upper slide covers part of the canvas where no paint can be applied without loosening, moving and then resetting the canvas.

#4b is the bottom slide of the easel which is the vertically adjustable wide support for the canvas that is set in place first. It has a lip which covers a larger area of the canvas that cannot be painted. The canvas bridge raises the canvas up from the bottom slide allowing full exposure of the canvas which is to be painted.

#5 is the canvas

What is claimed is:

1) The Canvas Bridge creates superior stability of an artist canvas, while set into an artist easel, without applying pressure directly upon the canvas' wooden stretcher bars which causes bending of the stretcher bar and therefore, sagging and loosening the canvas. When canvas is tight and is secure within the easel it is the best possible way in which paint can be applied to a canvas. When the Canvas Bridge is used it transfers the downward pressure that normally is applied directly upon the center of the upper stretcher bar and shifts the pressure towards the ends. This allows the canvas to stay tight as well as secure within the easel.

2) The Canvas Bridge also allows full coverage of the canvas that an easel makes impossible because there is a lip on the upper and lower adjustable supports of an easel.
